(19) United States
(12) Patent Application Publication
(10) Pub. No.: US 2002/0116375 A1
(43) Pub. Date: Aug. 22, 2002

(54) Method of searching for data or data-holding resources stored currently or at an earlier time on a distributed system, where account is taken of the time of its/their availability

(76) Inventors: Markus Blume, Munchen (DE); Markus Hoffmann, Landshut (DE)

Correspondence Address: THE H.T. THAN LAW GROUP, SUTTON EXECUTIVE CENTER, 3201 NEW MEXICO AVEUE, N.W., SUITE 350, WASHINGTON, DC, 20016, US

(21) Appl. No.: 10/080,894

(22) Filed: Feb. 22, 2002

(30) Foreign Application Priority Data
Feb. 22, 2001 (DE) 101 08 564.8

(51) Int. Cl. G06F 7/00

(52) U.S. Cl. 707/3

(57) ABSTRACT

In a method of searching for data or data-holding resources (2b, 5-10) stored on a distributed system (1), the data stored on the system (1) contains a sequential time indicator relating to the point in time or period when the data is or was available on the system (1). The search terms which define the search conditions comprise a time parameter which confines the search to the point in time and/or period defined by the time parameter. In a method of accessing resources (2b, 5-10) on a distributed system and of receiving and/or displaying data stored on said resources (2b, 5-10), when the data is displayed the information contained in the sequential time indicator is shown at the same time, and access to the data on the system (1) takes place as a function of a presettable time parameter.

The present invention relates to a method of searching for data or data-holding resources stored currently or at an earlier time on a distributed system and to a method of accessing the resources of a distributed system and of receiving and/or displaying data stored currently or at an earlier time on these resources, with account being taken of the time of the availability of the data on the system. In particular the invention relates to a method of searching for and accessing data on the internet.

In its present-day form the internet provides an opportunity of gaining access to extensive information and data holdings. It is for example possible in this case with the help of so-called search engines to make a targeted search for data which is intended to meet preset search conditions. The search facilities available and the data holdings to which access can be gained are considerably more comprehensive in this case than they are in the case of a conventional library.

However, it is a characteristic feature of the internet that the information which is available changes very quickly. Depending on the type of information they contain, the content of so-called web sites is updated at regular intervals or even continuously. It is estimated that the average life of a web site, i.e. the time for which the data remains unchanged, is about 70 days. If the data is updated, it has not so far been the general practice for the data originally available to be stored or archived and it has therefore been irrecoverably lost. Compared with a conventional library, it is therefore only the current state of knowledge that can be called up when a search is made on the internet. It is not however possible to tell from the data available on the internet how this state of knowledge developed over the course of time.

Since a high proportion of information is by now being made available only on the internet, there is thus a danger that a by no means negligible proportion of data and knowledge will be lost again after only a short time, another reason for this being that the relevance of data and information which is published sometimes only becomes apparent after a fairly long period of time. If it has already been deleted again in the meantime, there is often no way of reconstructing it. Consequently the citability of internet resources is very limited given that it is uncertain whether information or data will still be able to be called up in the long term. Either the storage location may change or the data may disappear completely.

It is often not just of historical but also of practical interest to know the state of knowledge which existed at a given time in a given area. To allow the patentability of an invention to be assessed for example, it is necessary for account to be taken of the prior art that was available at the time when the invention was applied for. However, there are limits to how far the information on the internet can be appealed to for this purpose because it only gives a picture of the current state of knowledge but does not as a rule say anything about the point in time from which this knowledge existed. Hence, it is essentially only by reference to printed publications that inventions can be assessed at the moment, though these do now and will to an even greater degree in future cover only a small amount of knowledge in comparison with the data on the internet. Another problem in this connection is that, in contrast to printed works, it has not so far been possible to verify when such data became available for the first time.

Some initial attempts have in the meantime been made to archive the data made available on the internet. The Internet Archive (wvw.archive.org) for example has been set up where the contents of web pages is stored on data tapes to prevent the data contained on it from being lost if a web page is changed. Also the stored data is provided with an item of information which says at what time the data was stored. This makes it possible for the information content of a web page at an earlier date to be learned by calling up the data stored in the archive. The alexa.com and google.com web pages also store data from the internet but this data is overwritten if more recent data from the same resources is stored, so that what is publicly available is always only the last version stored.

Also known, from U.S. Pat. No. 5,933,832, is a method of preparing a database where the stored data is provided with a sequential time indicator which says when the data was updated. However, with this method too there is no way of making a targeted search for, or accessing, data which was available to the public at a given time or period of time.

Another possibility is to extend the scope of proxy servers (information on AT&T's iProxy project can be found at: http://www.research.att.com/iproxy/archive/), which act as intermediaries in providing the internet user with access to the system, in such a way that they form a personal archive for the particular user. When this is the case it is possible for the user to store in his personal archive the internet page he currently has called up together with information on the time of storage. If he accesses his personal archive at some later time it is possible for him to recover pages substantially in the form in which they were available on the internet at an earlier point in time. The content of this archive is however confined simply to the information deliberately selected and saved by the user and it therefore does not give a comprehensive overview of the state of knowledge in a subject area at a given point in time.

Also known from U.S. Pat. No. 5,933,832 is a method of preparing a database where the stored data is provided with a sequential time indicator which says when the data was updated. However, with this method too there is no way of making a targeted search for, or accessing, data which was available to the public at a given time or period of time.

What is more, neither with the Internet Archive nor the personal archive is there any possibility of making a targeted search for information because what are involved there are pure databases which do not provide any facilities for making a search under given search conditions.

The object of the present invention is therefore to specify a scheme for accessing and searching for data or data-holding resources currently or formerly stored on a distributed system, with account being taken of the point in time at which the data was available. The invention relates in this case not only to the internet but to all distributed or networked systems which make data available and hence to intranets, extranets, LAN's, WAN's or metropolitan AN's for example as well.

The object is achieved by means of the methods and apparatus detailed in the independent claims.

In a first aspect the invention relates to a method of searching for data currently or formerly stored on a distributed system or for resources which hold data. By resources is meant all uniquely locatable storage locations for data and in the case of the internet for example the storage locations which can be located by a URL (uniform resource locator) or by a corresponding standard means. Data then means the web pages available on for example a resource including the files which the pages comprise and/or are connected to. Strictly speaking, provided they are uniquely addressable these pages may in turn even constitute a resource in themselves. For the sake of clarity however, what will mainly be referred to below will be data.

The method according to the invention comprises three steps, with an enquiry containing one or more search terms first being transmitted to a search unit. In a further step a search is made on the distributed system for resources or data which meet the condition(s) defined by the search term(s) or for information relating to such data, and in a concluding step the data found by the search and/or the information relating to the resources holding such data is output. The search may take place in this case, as is normal with search engines on the internet, in such a way that the distributed system is not fully searched at each enquiry but the search engine is connected to a memory which contains images or indicators (“fingerprints”) of the data which exists on the distributed system. The search is then made simply in this memory and the search results then point to the particular data records or resources on the distributed system. In accordance with the invention the data contains a sequential time indicator relating to the time or period when it was available on the system, in which case the search terms may comprise a time parameter which confines the search to the point in time and/or period defined by the time parameter.

The method according to the invention thus makes it possible not only to search for given resources or information on a given subject area or matching given search terms but in addition for the search to be confined to given periods or points in time. This provides an opportunity of learning what the state of knowledge was in a given area at an earlier point in time and thus for example of tracking how it developed over time in this area. Hence the method according to the invention provides the same opportunities as exist when making a search in a conventional library, it being possible for the search to be made in a considerably easier and more efficient manner in this case due to the computer-assisted automated processing of the enquiry.

Refinements of the said method according to the invention for searching for data or data-holding resources form the subject of subclaims. In particular, the search unit is preferably implemented in the form of a computer program which is for example made available by certain resources on the system. In this aspect, the invention relates in particular to a search engine for searching for data or data-holding resources stored on a distributed system, the search engine being so designed that it performs the search in the manner just described.

In a further aspect, the present invention relates to a method of accessing resources on a distributed system and of receiving and/or displaying data stored currently or at an earlier time on said resources, this being understood also to mean access to the data archived in an archive or on a memory network. In this case the data once again contains a sequential time indicator relating to the point in time or period when it was available on the system, in which case, if the data called up is displayed, the information contained in the time indicator may also be displayed at the same time. The point in time at which the data displayed was available is thus apparent to a user at any time.

This method too is preferably implemented with the help of a computer program. In this aspect, the invention relates in particular to a browser for accessing the resources of a distributed system or to the display, performed in the browser, of the access to the resources of a distributed system. Refinements form the subject of subclaims.

In a third aspect of the invention, which also relates to a method of accessing the resources of a distributed system and for receiving and/or displaying data stored currently or at an earlier time on said resources, the access to the data on the system takes place as a function of a presettable time parameter, in which case the data stored on the system also contains the sequential time indicator relating to the time or period of availability on the system.

To supplement the method described above, not only is there display of the information contained in the time indicator of the data but in fact what now happens is that access to the data takes place in a targeted manner such that only the data which was available at a presettable and possibly earlier point in time or period is accessed. There is thus an opportunity of determining the information content of resources at an earlier point in time. It also provides an opportunity of moving not just simply through the distributed system currently available, as was possible hitherto, but also in a temporal dimension as well. It is for example easily possible in this way for the development of a given resource over time to be observed. Alternatively, it would now be possible to move in the distributed system in such a way that the system behaved in the form in which it was available at a given earlier point in time.

In this third aspect too, the invention relates in particular to a browser for accessing the resources of a distributed system or to the display, performed in the browser, of the access, for which access a time parameter can be preset, the access to the data on the system taking place as a function of this time parameter. Further developments of this aspect of the invention similarly form the subject of subclaims.

Finally, in a further aspect, the invention relates to a method of archiving data stored on a distributed system. In this case data is first called up or received from the distributed system, then has a sequential time indicator relating to the point in time or period when the data was available on the system added to it, provided the data does not yet have a sequential time indicator, and is finally archived in a data archive or a repository in such a way that access to the data can be effected by search engines, browsers or programs. Alternatively, the archiving can take place at any desired point in the distributed system, in which case an item of verification information relating to the data can then be archived in addition in a repository.

The present invention thus provides a self-contained scheme which makes it possible for use to be made of the full information content of the data on a distributed system while taking account of the development of the data over time. Convenient and powerful search and display facilities are thus made available.

In what follows the invention will be explained in detail by reference to the accompanying drawings. In the drawings:

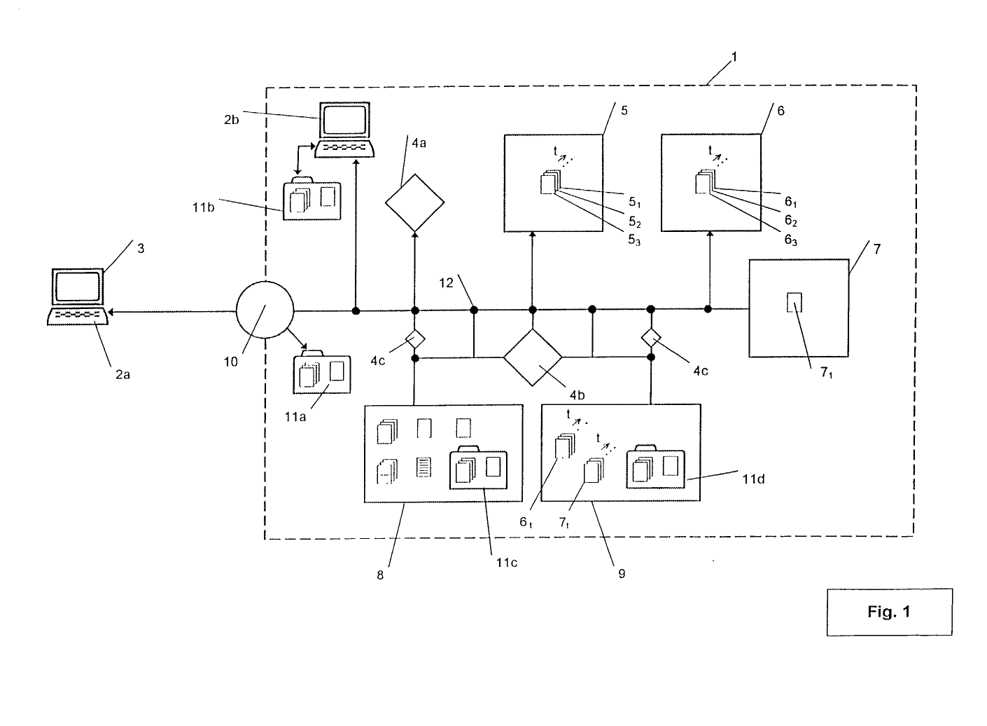

FIG. 1 is a diagrammatic representation of a distributed system to allow the present invention to be explained,

FIG. 2 is a representation of the window of a browser according to the invention which provides an opportunity of taking account of the time or period of availability of data when accessing and displaying it, and

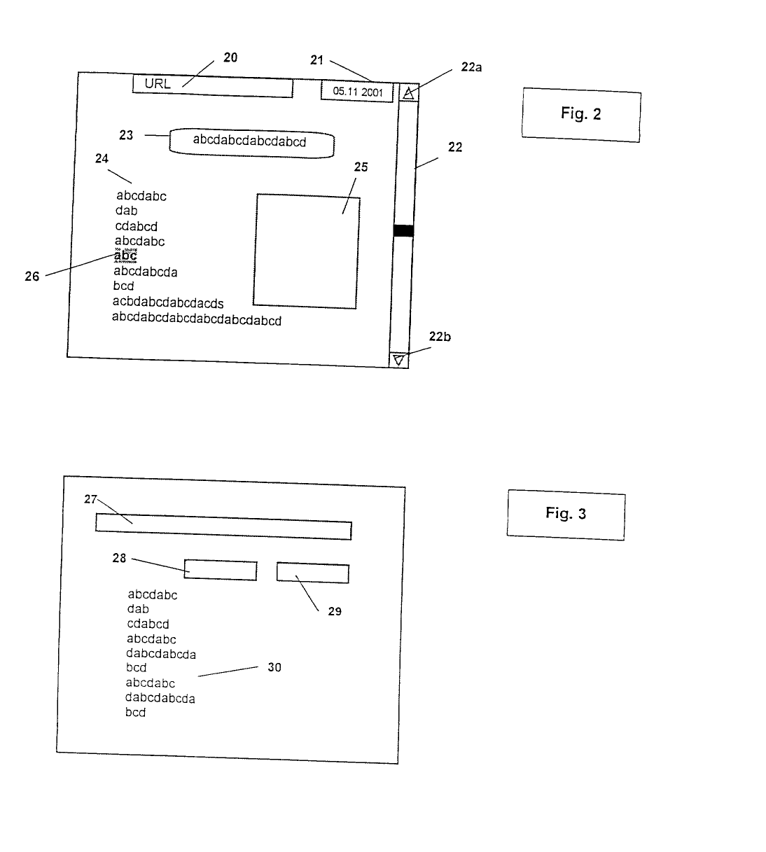

FIG. 3 is a representation of a search engine according to the invention which makes it possible for allowance to be made for temporal aspects when searching for data.

By reference to FIG. 1, the construction of a networked or distributed system and the corresponding resources, together with the nature of the data available, will first be explained in detail. This will be done by taking the internet as an example though the invention relates to any conceivable distributed systems which made data available and thus to intranets, extranets, LAN's, WAN's and metropolitan AN's as well.

In the present case the distributed system 1 comprises a range of different resources 4 to 10 and 2b, i.e. uniquely locatable storage locations which hold data. In the case of the internet the resources 4 to 10 and 2b are locatable by their URL, or in the most general case by some corresponding standard means. To be exact, even that component of a resource which is itself uniquely locatable may itself constitute a resource.

Resources 5 to 7 each contain data capable of being called up, in the form for example of web pages written in HTML or some other hypertext standard including the files connected thereto. Reference numeral 2b identifies a user terminal which can act as a resource provided the data stored thereon is part of a component of a memory network. The nature of the memory network will be explained later. Reference numeral 8 identifies a further resource which is a public repository. Data made available by resources 5 to 7 can be selected in a targeted manner and copied to this public repository 8—also referred to as a trust center—to be saved, or resource 8 can be instructed to copy the data in question. The operation of the repository 8 will be explained in more detail later on. Also forming part of system 1 is a data archive 9 in which the data from resources 6 and 7 for example is systematically stored for archiving purposes. Finally, system 1 comprises as further resources search engines 4a or 4b the purpose of which is to assist a user connected to system 1, represented by a further user terminal 2a, or the user of terminal 2b, in searching for data made available by resources 5-7 or archives 8, 9 or data made available in the context of a memory network 2b or 10. In the same way search engines 4a, 4b can be used by programs, represented for example by an intelligent agent 12, which carry our automated searches for the benefit of other resources, archives or users. In this case search unit 4c acts simply as an interface to assist only the search in archives 8 and 9.

The user 2a can be connected to the system via a proxy system 10 in this case or directly as in the case of user 2b.

There are also private archives identified as 11a-d, which may be part of resources 2b, 8, 9 or 10. The operation of these private archives 11a-d too will be explained in more detail later on.

Before the methods according to the invention of searching for and accessing resources or data with account taken of the temporal aspect are explained, the way in which the data available is archived will first be discussed.

The data records 5₁ to 7₁ which are subscripted 1 represent in this case the latest data holdings made available by resources 5 to 7, i.e. the data records which were updated last. Resource 5 for example also makes available not just the latest data record 5₁ but also a plurality of data records 5₂ and 5₃ which were published at earlier points in time and have now been archived. In the case of the internet, these archived data records 5₂ and 5₃ represent web pages in a form in which they were available at earlier points in time.

The archived data records 5₂ and 5₃ may be stored in this case in their original format together with their full contents and, where appropriate, the data or resources which are connected to them by links, thus enabling them to be displayed, by a browser or some alternative reproduction program for example, legibly and in precisely the form in which they were available at an earlier point in time. This implies that at the time of archiving, the download files for example which are behind the graphic interface (e.g. Pdf files, Word documents, etc.) and to which connections are made by the links are also saved. If the data records also include scripts, applets or contents pulled in dynamically from other resources, these items too can be archived.

However, to make a reduction in the scope of the data, provision may also be made for the data records 5₂, 5₃ to be archived in compressed form or, where appropriate, for individual items that are not material to the information content to be excluded. The advertisements or advertising banners which are often shown on internet pages for example could be excluded from the archiving. If the data includes dynamic items or items which depend on the configurations set or details entered by a user, these are preferably saved at the time of archiving in such a way that they appear as standard at the time of first call-up.

The point in time when data is saved for archiving purposes may differ in this case with the nature and content of the data. Provision may for example be made for the data to be saved at regular intervals such as every few days, weeks or months. Another possibility is for archiving to be performed only when the content of the data has changed to a certain degree, which can for example be determined by a comparison between the data last archived and the current data, with the help of checksum processes or the like where appropriate. When this is the case, to reduce the volume of data provision may also be made for only relative changes to be saved, and for full archiving of the data to take place only if the total changes amount to more than a complete fresh save.

What is essential is that when data is archived the data saved last is not overwritten and hence lost but that, as an ongoing process, the archiving takes place in such a way that the complete development of, for example, the data made available by resource 5 can be followed from the current data record 51 and the set of archived data records 5₂, 5₃.

What data is archived and at what location may also depend on various conditions. Thus resource 5 for example itself archives its data records 5₁ to 5₃ in their entirety and thus makes available a complete set of data records. This is also the case with the second resource 6, in which its own data records 6₁ to 6₃ are likewise archived over the course of time, but it is not the case with resource 7. Archive 9 may make a claim to archive all the data records 5₁ to 5₃, 6₁ to 6₃ and 7₁ made available on the distributed system by resources 5-7. This is true regardless of whether the resources archive their data themselves for general access, as resources 5 and 6 do but resource 7 does not. It is also conceivable that, for whatever reason, only the earlier data is archived for certain resources, such as, in the present example, the earlier data records 6₁ and 7₁ for resources 6 and 7 but not those for resource 5.

Archive 9 may however also be provided to archive only the information relating to a certain subject area. If data relating to this subject area is published by resources 5-7, it is systematically archived in archive 9.

The saving or copying of data to archive 9 may for example be performed with the help of automatic robot processes. Systematic scanning and archiving are then carried out with the help of such processes by reference to the addressing, interlinking by cross-references, frequency of updating or relevance of the various resources. The possibility exists in this case of use being made of so-called “self-teaching” processes where the frequency of scanning is made dependent on the frequency with which the data is updated and the scope of the changes. The “teaching” in this case can be performed by means of mathematical processes, based on neuron networks for example, with the frequency of scanning being adjusted automatically to give optimum archiving. What this means for example is that the frequency of archiving is increased when the data is updated more often, whereas by contrast, archiving takes place only at long intervals if the data remains unchanged for a long period. Account may also be taken of the nature of the changes to the content, with for example account being taken only of the content of texts contained in the data to allow an assessment to be made of whether or not archiving is to take place.

However, as well as for systematic archiving with the help of robot processes, provision may also be made for an archiving operation to take place simply in response to a targeted request. Resource 6 may for example cause archiving to take place in archive 9 at regular intervals or at times when the data has been updated, on its own initiative. This can be achieved by means of applets, scripts or other software solutions which are supplied for setting up on the relevant resource. This is particularly advantageous in the case of resource 7 because, unlike resources 5 and 6, it does not itself undertake any archiving of the data made available by it. If in the example shown the data in resource 7 is updated, then the data previously made available will be copied to archive 9, which means that the latter will contain a complete set of the data records 7ₜ which were made available at earlier points in time. It is of course also possible, as a result of either user 2a or 2b entering a given resource, for a request to be made to archive 9 for it to archive this data or resource. The interface for the entry may run on a resource of its own or it may be incorporated in software, such as in the user's browser for example.

Archive 9 may also form the basis of an expert system which allows the selective output of data of given contents, on given subjects, of given categories, in given formats and for given points in time or intervals. Searches in the archive may be made in this case via a dedicated interface, such as a search unit 4c. It is however also possible for archive 9 to be so designed that from the outset it is only data specified in terms of content or other categories which is archived.

Generally speaking, the possibility will also exist for the archived data to be accessible only against payment of a certain fee, in which case the original providers of the data, i.e. the resources 6 and 7 from which the data originally came, may be given a share of the proceeds, for example by the micropricing form of settlement.

Another possibility which exists is for data which is not directly accessible to the public on system 1 but can only be reached via a further, and if necessary password-protected, interface to be stored in archives 8 and 9. This so-called “invisible net” or “deep web” is a region of the internet to which users cannot gain access by exerting control on resources; instead the region exists in the form of databases which can be scanned via certain interfaces on the resources formed by the databases. In this case archiving may comprise the possibility of direct access taking place, for archiving purposes, to the databases situated behind the scanning interface, after an appropriate agreement has been reached where necessary, which could even be negotiated automatically by a software solution between the resource and the archive/robot.

Provision may be made for the data in archives 8 and 9 to be labelled with an additional notation which says that access is only possible if a fee is paid or under some other restriction. Provision may be made in this case for the availability of such data to be indicated as part of a search but for the call-up of the data to be possible only against payment of a fee. This may also comprise the data being already marked by the original resource 5-7 to say that it can only be called up under certain conditions, such as a fee being paid for example. This can apply in particular to data from the invisible net.

There are other functions which the public repository or trust center 8 performs. A first function comprises causing the publication of certain data from resources 5-7 to be documented or verified. One reason for which archiving of this kind may be of interest is for example if it needs to be proved that certain information was already available at a certain point in time. It is for example possible in this way clearly to establish whether a piece of information which would be a bar to the patentability of an invention was already available to the public prior to the determining priority date of the application. Hence it is question of documenting and verifying the origin, point in time and content of data and resources and protecting them from being manipulated.

The method makes provision for the instructions to the repository 8, i.e. the request for archiving, to be given for example from pages available to a user 2a or 2b, who gives instructions for certain data from a resource 5-7 to be scanned and to be stored at the trust center 8, together with details relating to point in time and origin. Storage of data at the trust center 8 may equally well take place in response to a request made by a resource. Both processes can take place either manually (i.e. in response to case by case requests) or automatically by means of a software solution, as was described in the case of the storage in archive 9. The storage may in this case also comprise further layers of files, these layers being connected to the data to be saved by means of links, being archived as well. How many layers are to be stored when this is the case may be made dependent on the user configuration.

In this connection there is a special case which arises, which is the possibility of causing certain dynamic contents—as determined by scans, user inputs or previous settings—to be documented and verified. This is for example relevant when (purchase) agreements are made over the internet. When this is the case, the storage may take place in such a way that the scan is made via the inserted repository 8 and the dynamically generated contents can be verified and documented in this way. Another possibility is for the repository 8 to make the enquiry in quasi-parallel with the configuring by the user. Since the data in question is of no interest to the public, generally speaking, it may be stored either in a not generally accessible part of the repository 8 which can be looked at only by one or more more closely defined users, such as in a private archive 11c for example. Another possibility is for only a verification stamp to be given while the actual data is stored at the user's end. The operation of the verification stamp will be explained below.

Another function is for certain contents or resources to be made citable following a request by users 2a, 2b or a virtual agent 12. For this purpose it must be ensured that certain contents identified by their origin and point in time are stored in a durable and unalterable form. The security criteria which are employed for the storage of data and for the checking for possible changes to data during the transmission processes from and to the trust center 8 may be those given in the German Signature Law. The method in this case is organised as described above.

A third function of the repository 8 may comprise the repository 8 documenting or verifying the state of knowledge in a given field at a given point in time which has been assembled by for example an expert system, independently of any request for the actual storage of given data or resources. Hence the trust center 8 may itself archive data from resources 5-7 by a method similar to that described for archive 9. In particular, data at given resources may be monitored and if required archived automatically for a fee, at regular intervals.

The trust centre 8 ensures that the data is available at all times but at the same time that any manipulation is ruled out, so that the data which is scanned from the trust center 8 at a later point in time will be identical to the data which was originally available on the distributed system. For this purpose the relevant data may be archived in complete form at the trust centre 8, as described above. However, it is also conceivable for a digital verification stamp or “fingerprint” to be generated by the trust center 8. The stamp contains coded details relating to point in time, origin and content. A copy of the stamp is stored at the repository 8. There is then no need for the storage of the data or resources to take place at the trust center 8 and instead it can take place on resources 5-7, in archive 9 or in a personal archive 11a-b (i.e. even at a user, if required on the memory network). If the data which has been stored and verified in this way is called up at a later date, it can then be established by comparing the verification stamp or fingerprint whether the data in question is identical to that originally verified.

Particularly from the copyright point of view, the very thing that may be advisable is for it to not be possible for all the resources to store data in such a way that it is, or is to be, permanently publicly accessible to everybody. When this is the case, there will still be the possibility of decentralised storage, at user 2a or 2b for example; as mentioned, only a copy of the verification stamp would be stored at trust center 8. With regard to the first two functions of trust center 8, provision may be made for the user or, in more general terms, the giver of instructions for the archiving/verification of the data, to be notified on completion of the verification or archiving process and for him also to be informed that the publication or citation specified by him is permanently documented or citable.

General speaking, the first two functions of the trust center 8 may be performed for payment of a fee, or the use of data which is archived or verified as part of the third function may be subject to a fee.

In parallel with the methods of storage in archives 8 and 9 which are described above, the possibility also exists of personal archives being set up to which only a given user or a closely defined set of users may have access. These may be designed as “virtual archives” such as 11c and 11d, in which information from archives 8 and 9 is filtered in accordance with user specifications and if required is displayed in processed form. Hence a section of the total archive can be viewed in the personal archive. It is for example also possible for an overview of all the archiving operations asked for to date or of all the data archived to data to be shown. Another possibility is for data to be shown in private archives 11c and 11d which, although stored in archives 8 and 9, is intended only for a certain set of users and not for the general public. Archives 11a and 11b on the other hand are actual storage locations in the sense that data, together with its point in time and origin, can be archived in them directly. Personal archive 11b forms part of user terminal 2b. Finally, it is also open to user 2a to create a personal archive 11a to which only he, or a closely defined set of persons, has access via a suitable proxy server 10.

Archiving in personal archives 11a and 11b may for example take place automatically when user 2a or 2b accesses certain data on system 1. However, it is also possible for automatic processes to be provided for archiving as in the case of trust center 8 and archive 9. It is equally possible for data and resources to be archived in personal archives 11a and 11b when the user gives the appropriate command by direct input at an interface by means of a software solution, such as a button incorporated in the user's browser for example. Functional extensions of personal archive 11c or 11d may relate to the user being notified when new data is accepted.

In addition to this, provision may be made not only for users 2a and 2b to have access to their respective personal archives 11a and 11b but also for them to make their archives available to the general public. When this is the case, personal archives 11a and 11b perform the same function as archive 9 but contain only the data archived in them personally by users 2a and 2b respectively. This makes it possible for a complete network of personal archives to be made available, i.e. for a decentralised memory network to be created which, seen as a whole, can contain a high proportion of the data which was made available in the past by system 1.

It is important to point out that all the archived data, regardless of whether it was archived by resources 5 and 6 themselves, trust centre 8, archive 9 or private archives 11a-b, comprises a sequential time indicator which says at what point in time or for what period the data was available on the system. Available in this case is intended to mean that the data was accessible in principle at this moment. The time indicator may be one-, two- or multi-dimensional in this case. One-dimensional means that the time of availability specified is only a single point in time. Two-dimensional means that an interval of time (continuum) over which the data was available is specified by means of two points in time. Hence multi-dimensional means that a plurality of individual points in time and/or intervals of availability are specified. It is better for data at individual resources to comprise one- or preferably two-dimensional time indicators and for archived data to comprise multi-dimensional ones as well.

The point in time or period of availability can be specified in a variety of ways. In the simplest case, the original resource 5-7 gives the data a sequence time indicator. This will normally be the point in time at which the data was published for the first time or the period from the said point in time when the data was published to the present point in time or to the point in time at which the first change was made. The time indicator may also comprise an indication of the time standard under which it was determined (local time, but probably GMT as a rule).

The point in time assigned by the resources can then be transferred when the data is called up or in other words when it is transferred to one of archives 8, 9 or 11a or 11b. If the resource does not itself give a time indicator, the time of the call-up or the archiving can be used as a time indicator; where an ongoing check is made it may also be a period.

For various reasons, there are also other time indicators which can be given at the time of archiving. Particularly when it is a question of certain data and points in time/periods being verified, i.e. when archiving takes place at the trust center 8, it needs to be ensured that the data was in fact accessible at the points in time specified by the resource or that it has not been altered retrospectively. In this case, the trust center 8 will be able to accept only assured points in time for the time indicator; such a one is for example the moment when the data is called up (by a robot or manually). Consequently, it will only be possible for a period (i.e. a continuum of availability) to be specified if an ongoing check is made on accessibility or availability. By means of a software solution, the arrangement made for this purpose may be that the resource contacts the trust center regularly for as long as the data is available or that the trust center 8 or archive 9 is automatically notified if there are changes.

The same is true, with the appropriate changes, of the verification by means of the verification stamp. For verification to be possible, the verification stamp must be stored at exactly the point in time at which the data was received or, in the case of verification, the time indicator which the data has must automatically be the point in time at which the verification stamp was generated.

It is also important for it to be mentioned that all the data which is not archived at the original resources 5 and 6 contains an indication of the source from which it originally came.

As an option, the archived data may contain other notations, such for example as references to identical data records at other resources, as a result of which it becomes possible to correlate data records which come from different resources but whose contents are identical. One possible form of reference of this kind may take is a reference to the URN (uniform resource name) of a document, i.e. a resource-independent identifying attribute for data. This all becomes important when it is a question of finding identical data records which, over the course of time, could be found on different resources. The notations relating to identical data records can also be added to by user input at a suitable interface. This is useful when for example the data is changing over to a different resource. This can be noted by user input or automatically and it subsequently gives the data a temporal continuity even if the resource has changed. The data may also have embargoing notations which allow it to be available only from a given point in time or for payment of a fee.

Basically it is conceivable for the notations for sequential indication, time, availability, fee payment, confidentiality etc. to be stored on the resource together with the file name as further file properties. This would also make direct access possible by means of a suitably expanded locator on the files. Additionally, or as an alternative, this information could also be stored in the file itself (in the header in the case of HTML documents for example). However, it is also conceivable for all or some of the indicator information to be stored centrally in a dedicated database file on the appropriate resource or some other resource on the distributed system. Direct addressing (by means of an expanded locator for example) will only be possible in this case insofar as the access enquiry for a given file first has to be directed to the resource which has the indicator information. The latter interprets the enquiry accordingly and then passes it on so that access is given directly to the desired file.

In the case of the internet, a possible way of addressing data lies in expanding the standard URL into an expanded locator, such as a uniform resource and time locator (URTL) for example. As well as the resource addressing facility, this new locator for resources on the distributed system will also comprise a time addressing facility, i.e. it is expanded to include a time component or time parameter. This being the case, it is possible for different data records, such as web pages for example, which are reached under one and the same URL over the course of time, to be homed in on individually by mean of the expanded locator. The additional details of time in this case are a further parameter for addressing which, when the data is accessed, is able to be recognised as such and to be processed directly. Where addressing is to the conventional standard, i.e. with no details of time, provision may be made for access to take place as standard to the most up-to-date data.

Where details are given by the expanded locator, access can also be made specifically to data which was available under the same resource but at an earlier point in time, such as data records 5₂ and 5₃ in the case of resource 5 for example. In other words the data records can be called up directly from the resource addressed. If the resource does not have any stored data for the point in time or interval in question, provision may be made for automatic access to archives 8, 9 and/or 11a or 11b. If a resource or the archives does not per se have any data for the time given in the locator, then the corresponding data which is closest in time can be called up automatically from the resource or, where required, from an archive (8, 9, 11a, 11b). Provision may also be made for the enquiry or access to be passed on to the archives or the search engines 4a, 4b with the aim of having a selectable range of similar or identical documents overlaid on the screen (e.g. by means of URN's), in a pop-up window for example.

If the expanded locator is not supported by transmission protocols, the network infrastructure and/or individual resources on the distributed system, the expanded locator can be simulated by making use of the existing URL specifications so that two-dimensional addressing by resource and time is possible. This presupposes that there will also be a suitable software solution to enable the resources to interpret the details coded in this way in the URL format.

At the user end, the simulation of this new standard may be effected by an expansion of the software of the proxy server 10, which extension converts the enquiries for data which are combined with a given point in time into suitable commands for access to resources 5-7 or archives 8, 9, 11a or 11b. The same can also be achieved by a suitable expansion at the user terminal, to the browser for example, in such a way that the two-dimensional input of resource and time is encoded to the URL standard by software.

In what follows, the method according to the invention of accessing the individual resources on the system and of receiving and/or displaying the data stored on the resources will be explained. In particular, it will be explained by taking the internet and the particular display facilities in a browser as examples. Access is effected in this case by means of a browser installed on the computer 2a or 2b, via which enquiries for data held on given resources can be passed on to the appropriate resources, via a proxy server 10 if necessary. FIG. 2 is a diagrammatic view of a window belonging to the browser which is displayed on the monitor 3 of computer 2a. In an address field 20 at the top is shown the address of the resource which is to be accessed. Next to this address field 20 is a further time field 21 which gives details of the sequential time indicator accompanying the data displayed.

Where data is to be accessed, the address of the desired resource has to be entered in address field 20 and at the same time a time parameter can be specified in time field 21 which gives details of the point in time or the period from which the desired data is to originate. If the time parameter is omitted then, as described above, the latest version of the stored data can be requested. It is not of course necessary for the input or output of the time parameter to take place via a dedicated time field and it could be entered or displayed within the address field as part of what would thus be an expanded address.

The addresses and time parameters entered are then passed on directly to the appropriate resource 5-7, via the proxy server 10 if necessary and in a simulated URTL locator if necessary. If this enquiry fails to produce a result (because the resource cannot be reached, because it does not support the standard or because it does not have any data to which the time parameter applies), the enquiry is passed on to one of archives 8, 9 and/or 11a, b.

Parallel enquiries to resources and archives are of course also conceivable. If it is found that the data enquired for is available from a plurality of resources or archives at the same time then if the data records concerned do not agree with one another is it preferably the data from the trust center 8 or the data which is checked by means of the verification stamp which is called up, because this has always been protected against any retrospective manipulation. If data from the desired period is not available either in resource 5-7 or in archives 8, 9 or 11a, b, then provision may be made either for the data currently made available by the resource to be automatically accessed or for a search to be made for date which was available before or after the desired period. Alternatively, alternative resources which contain identical or similar data may be output and shown in, for example, an extra window or a part of the browser. The procedure which operates via URN's or indicator notations is described above.

When data is displayed, the sequential time indicator, or the information relating to the data shown on the browser window which is contained in the time indicator, is displayed at the same time in the time field 21, thus making it possible to see at any time the period from which the data displayed originates. Some alternative form of display is of course conceivable, either implicitly in the address field or graphically as a bar representing time.

Since data is archived in its entirety in the ideal case, in the case of the internet an archived web page can be displayed in exactly the form in which it was originally available. When this is the case less relevant information, such as advertising banners 23 or the like, appear as well, as shown in FIG. 2. If however the data is archived only in a compressed or filtered form as described above, provision can be made for only the essential information, i.e. texts 24 and associated FIGS. 25, to be displayed.

Reference numeral 26 identifies a link which represents a cross-reference to further data or resources. Since the data to which the link 26 refers can be archived when the archiving is of the appropriate scope, then, when it is, clicking on the link 26 will automatically cause the information, including the time-related information, to which the link 26 relates to be displayed. This makes it possible to navigate through the system to a fixed, preset point in time. If the data to which the link 26 relates has not been stored either on the resource or in one of the archives 8, 9, 11a or 11b, then provision may be made for that information which is available and is closest in time to the preset point in time to be accessed. Alternatively, provision may also be made for it to be necessary for a new point in time to be specified for access to be made. If required, an overview of the points in time for which data is available can be overlaid on the screen (e.g. as a pop-up window).

Also shown on one side of the browser window is a time bar 22 which makes it possible to navigate in the temporal dimension on the web page displayed. What this means is that clicking on the top arrow 22a automatically causes the data which was archived after the data currently being shown on the window to be accessed. Clicking on the bottom arrow 22b on the other hand automatically causes data which is one increment of time older to be accessed.

Also provided on the browser shown in FIG. 2 there may be buttons which can be used to preset temporal tolerances which are to be observed when dealing with the time parameter entered. It will for example be possible in this way to set the manner in which corresponding data from other periods is to be accessed if data from a desired period is not available. Another button can be used to make presettings as to whether and if so in what order the various data holdings on the system are to be referred back to, i.e. first to resources 5-7 or personal archive 11a-d, then to archive 9 and finally to trust center 8 for example.

If different resources are to be navigated between with the help of the browser, the particular time preset by time field 21 can be activated or deactivated. Activation means that only data which satisfies the time condition specified in time field 21 is to be accessed. This represents navigating to a fixed point in time in the past in the manner already described above. However, because of the frequent updating of the data available on the distributed system, it will often happen that cross-references to other data lead to resources which can no longer be reached or which are no longer supplying information appropriate to the then context. If there is not even any data appropriate to the then point in time stored in archives 8, 9, or 11a or 11b, then in a refinement of the method according to the invention provision may be made for the enquiry to be automatically expanded in this event into a search for the data which was archived last at the resource being searched for or for the data closest in time to the target point of time for the search. This ensures that the latest data which is available can always be shown. Deactivating the particular time preset by time field 21 on the other hand will mean that it is always the current or at least the latest available archived data at the relevant resource which is displayed.

Another expansion may comprise references to similar or identical data at another resource being shown in a separate window. This information could provide an indication that the resource actually being searched for can be reached at a new address and that the data is only being updated on this new resource. It can also be shown in an additional window what cross-references the data displayed has or what other data records contains cross-references to the data displayed in the browser window. The information required for this purpose is based on the indicating or reference notations described above or on search engines which are also able to categorise contents.

Finally, it is possible in the browser according to the invention for algorithms to be implemented which calculate the probable next access by the user as a function of the accesses made previously and automatically pre-fetch the appropriate data records on the system. This is relevant to for example the expansion just described if a plurality of alternatives of similar content are overlaid on the screen of which one is to be selected.

The method according to the invention makes it possible to navigate both between different resources and also, and in addition, in the temporal dimension. What is more, it can be ensured by means of appropriate expansions, even when setting the operation of a resource, that it is the latest data available that is transferred to archive 9 and that is displayed from the archive when enquiries are made to the resource in question.

Finally, the method according to the invention of searching for data or data-holding resources where account is taken of the point in time or period of availability will be explained.

Provided for this purpose are search engines 4a and 4b which make it possible for certain information to be searched for among the data made available by the various resources 5-9 and 11a and where required 11b on the system 1. For this purpose, in a first step the user 2a or 2b transmits an enquiry containing one or more search terms to search engine 4a or 4b. The latter searches on the system 1 for resources or data which satisfy the condition(s) set by the search terms. As is normal for search engines on the internet, the search may proceed in this case in such a way that the distributed system (including the archives) is not fully searched for every enquiry but the search engine is connected to a memory which contains images of or references (fingerprints) to the resources and data present on the distributed system. A search is then made only in this memory and the search results then point to the particular resources or data on the distributed system. As in the case of search engine 4b, this memory may in turn be the archive 9 or the test center 8 itself. The data which is found or the information which is found relating to the resources which hold the data located is then transmitted back to user 2a. FIG. 3 shows a window of a search engine 4a or 4b of the present kind, such as is shown on user 2a's monitor 3. The window usually has an input field 27 for entering search terms under which a search is to be made in the resources or data available. A plurality of search terms can also be combined with the usual logic functions (AND, OR, etc.) or exclusion criteria in this case.

As well as this the search engine also has one or more time parameter windows 28, 29 in which details of times can be entered and in this way one or more intervals or time can be specified if required. The details of time act as an additional search term in defining a time parameter by which the search is confined to data which was available on the system in the period which is preset. This makes it possible for the search to be made not just among the current data, as was the case hitherto, but also among the data which was available at an earlier point in time. In particular, this makes it possible to, for example, call up only the information on a given subject which was available at a given point in time in the past. The data or the data-holding resources can then be shown on the screen in for example the form of a table or list 30 or can be processed into a catalogue or in some other way, such as graphically for example.

Provision may be made in this case for access to the search engine 4a or 4b to take place not on a browser but via an inserted input interface along the lines of a dedicated software program. This interface can for example take the form of an add-on program which appears on the browser as a separate input window or a browser extension. This extension also makes it possible for certain entries or error messages resulting from the non-availability of data (meaning data behind the interface on the “invisible net”) or of resources (broken links) to be automatically converted into appropriate enquiries to the search engine. This results in a fresh search enquiry or a fresh access to data, which data is then automatically called up, reconstructed if necessary and displayed on the browser. Also, by means of the interface it is possible to display a catalogue for selecting certain terms or resources under which or in which the search is to be made. With this interface a scan can also be made under stored parameters specific to the user. As an alternative to a separate program, the expanded facilities provided by the interface may also be integrated into the browser.

In a similar way to the input interface just described, it is also possible for a corresponding interface to be provided for the output of data received from the system. When search terms and/or resources or groups of resources and/or times or other parameters are entered, this may automatically present the information found as a one- or multi-dimensional results list, sorted if required by the said parameters or other criteria governing relevance. Provision may be made in this case for the data to be displayed directly in its original format where an enquiry produces a unique result, for example when the enquiry is for a resource at a given time, whereas when a plurality of data records which satisfy the search criteria are found provision may be made for presentation as a results list or the output takes place in a catalogued, categorised or graphically processed form. To make display in the original format possible, the search engine or the resources must if required make programs or expansions available to the user.

If only a single resource is being searched for, then provision may be made for a graphic display of its life cycle, such as the development over time of the data stored on it (by marking the changes), or else its networking over time to other pages and resources. As an option, references may be displayed to other resources which are similar or identical or have a shared origin. The data found can be sorted, for example with the help of neuron or evolutionary algorithms. As well as this, provision may also be made for it to be possible for the results list to be fully searched again if a plurality of data records which satisfy the search criteria are found.

The method according to the invention which has been described of searching for data and data-holding resources where account is taken of time also provides an opportunity for example of making a search explicitly by the parameter of time, or in other words of searching for example for data which was available at a given point in time or within a given period or which changed within a preset period. This also implies the possibility of searching for resources or groups of resources on which data changed within a given period.

The present invention thus provides an opportunity of conveniently accessing resources or data made available on a distributed system and of searching for data providing corresponding information while at the same time taking into account the period of availability of said data. In this way the information content of the data material made available can be utilized in an extremely effective way.

The method according to the invention of searching for and accessing resources or data is preferably implemented in this case by means of software programs. Retrofitting to existing search engines or browsers which do not as yet support the method according to the invention can be performed in this case by means of add-on programs or applets.

1. Method of automated searching for data or data-holding resources stored on a distributed system which comprises the following steps:
transmitting an enquiry containing one or more search terms to a search unit,
searching for data or data-holding resources stored on the system which satisfy the condition defined by the search terms, and
outputting the data, and/or information relating to the resources which hold such data, which is found in the search,
wherein the data stored on the system comprises a sequential time indicator relating to the point in time or period when the data is or was available on the system,
and wherein the search terms comprise a time parameter which confines the search to the point in time and/or period defined by the time parameter.

2. Method according to claim 1,
characterised in that if there is no time parameter the search is carried out simply among the data currently made available by the resources.

3. Method according to claim 1,
characterised in that in the event of the search producing a unique result the data found is output directly.

4. Method according to claim 1,
characterised in that in the event of a plurality of data records or data-holding resources being found which satisfy the condition defined by the search terms, a list or graphic overview of the data records found or of the resources which hold the data found is output.

5. Computer program for carrying out a method of automated searching for data or data-holding resources stored on a distributed system according to claim 1.

6. Computer program according to claim 5,
characterised in that it is an add-on program for a search engine for searching for data or data-holding resources stored on a distributed system.

7. Search engine for automated searching for data or data-holding resources stored on a distributed system,
wherein the search engine is designed to receive an enquiry containing one or more search terms,
to search on the system for data or data-holding resources which satisfy the condition defined by the search terms, and
to output the data found in the search, and/or the information relating to the resources which hold said data, which is found in the search,
wherein the data stored on the system includes a sequential time indicator relating to the point in time or period when the data is or was available on the system,
and wherein the search terms comprise a time parameter which confines the search to the point in time and/or period defined by said time parameter.

8. Search engine according to claim 7,
characterised in that it searches for data or resources which satisfy the condition(s) defined by the search term(s) in a memory connected to it which makes references to the data or data-holding resources present on the system.

9. Search engine according to claim 7,
characterised in that if there is no time parameter the search is carried out simply among the data currently made available by the resources.

10. Method of accessing resources on a distributed system and of receiving and/or displaying data stored on said resources,
wherein the data stored on the system contains a sequential time indicator relating to the point in time or period when the data is or was available on the system and wherein, when the data is displayed, the information contained in the time indicator can be shown at the same time.

11. Method according to claim 10,
characterised in that the sequential time indicator forms an expansion of the locator for addressing the data.

12. Computer program for carrying out a method of accessing resources on a distributed system and of receiving and/or displaying data stored on said resources according to claim 10.

13. Computer program according to claim 12,
characterised in that it is an add-on program for a browser for accessing resources on a distributed system and for receiving and/or outputting data stored on said resources.

14. Browser for accessing resources on a distributed system and for receiving and/or displaying data stored on said resources,
wherein the data stored on the system contains a sequential time indicator relating to the point in time or period when the data is or was available on the system,
and wherein, when the data is displayed, the information contained in the time indicator can be shown at the same time.

15. Method of accessing resources on a distributed system and of receiving and/or displaying data stored on said resources,
wherein the data stored on the system contains a sequential time indicator relating to the point in time or period when the data is or was available on the system,
and wherein access to the data or the data-holding resources on the system takes place as a function of a presettable time parameter.

16. Method according to claim 15,
characterised in that the time indicator forms an expansion of the locator for addressing the data.

17. Method according to claim 15,
characterised in that if there is no time parameter it is simply the data currently made available by the resources which is accessed.

18. Method according to claim 15,
characterised in that in the event that no data whose sequential time indicator meets the condition preset by the time parameter is available on the resource which is accessed, an archive for archiving data is accessed.

19. Method according to claim 15,
characterised in that in the event that no data whose sequential time indicator meets the condition preset by the time parameter is available anywhere on the system, data which is or was available before or after the point in time or period specified by the time parameter is automatically accessed.

20. Computer program for carrying out a method of accessing resources on a distributed system and of receiving and/or displaying data stored on said resources according to claim 15.

21. Computer program according to claim 20,
characterised in that it is an add-on program for a browser for accessing resources on a distributed system and for receiving and/or outputting data stored on said resources.

22. Browser for accessing resources on a distributed system and for receiving and/or displaying data stored on said resources,
wherein the data stored on the system contains a sequential time indicator relating to the point in time or period when the data is or was available on the system,
and wherein access to the data or the data-holding resources on the system takes place as a function of a time parameter presettable for the browser.

23. Method of archiving data stored on a distributed system which comprises the following steps:
calling up or receiving data from the distributed system,
adding to the data a sequential time indicator relating to the point in time or period when the data is or was available on the system if the data does not as yet have a sequential time indicator, and
archiving the data in a data archive or a repository in such a way that the data can be accessed by search engines, browsers or programs.

24. Method of archiving data stored on a distributed system which comprises the following steps:
calling up or receiving data from the distributed system,
adding to the data a sequential time indicator relating to the point in time or period when the data is or was available on the system if the data does not as yet have a sequential time indicator, and
archiving the data in a data archive or a resource in such a way that the data can be accessed by search engines, browsers or programs and
archiving an item of verification information relating to the data in a repository.

25. Method according to claim 23 or 24,
characterised in that archiving of the data or the item of verification information in the repository takes place in such a way that any manipulation of the archived data or verification information is ruled out or any manipulation which there may be can be detected when data archived on the resources is called up.

26. Method according to either of claims 23 and 24,
characterised in that the archiving of the data takes place at the instigation of a user.

27. Method according to either of claims 23 and 24,
characterised in that the repository archives the data at the instigation of a resource.

28. Method according to either of claims 23 and 24,
characterised in that the repository archives the data on its own initiative following a preset scheme.
